(19) United States
(12) Patent Application Publication
(10) Pub. No.: US 2011/0249909 A1
(43) Pub. Date: Oct. 13, 2011

(54) FILTER AND FILTERING METHOD FOR REDUCING IMAGE NOISE

(75) Inventors: Tung-Hsin Lee, Hsinchu City (TW); Chun-Cheng Chiang, Hsinchu City (TW)

(73) Assignee: NOVATEK MICROELECTRONICS CORP., Hsinchu (TW)

(21) Appl. No.: 13/076,453

(22) Filed: Mar. 31, 2011

(30) Foreign Application Priority Data
Apr. 12, 2010 (TW) 99111257

(51) Int. Cl. G06K 9/40

(52) U.S. Cl. 382/264

(57) ABSTRACT

A filter for reducing image noise including a sum of absolute difference (SAD) unit and a weighting unit is provided. The SAD unit receives pixels of a target window and receives multiple pixels of multiple peripheral windows, which are neighboring to a target pixel of the target window. Each of the peripheral windows has a peripheral pixel neighboring to the target pixel. The SAD unit calculates absolute differences for each of the pixels corresponding to the target window and the peripheral window. The absolute differences are calculated by a difference calculation to obtain a difference analyzed value. The weighting unit receives each of the difference analyzed values and assigns multiple weights respectively to the peripheral pixels according to a data table.

### CROSS-REFERENCE TO RELATED APPLICATION

This application claims the priority benefit of Taiwan application serial no. 99111257, filed Apr. 12, 2010. The entirety of the above-mentioned patent application is hereby incorporated by reference herein and made a part of this specification.

### BACKGROUND

1. Field of the Disclosure

The present disclosure relates to a filtering technique for reducing image noise, by which during a process of reducing the image noise, details of an image has a considerable degree of preservation.

2. Description of Related Art

A digital image is formed by a plurality of pixels arranged in an array, and each of the pixels respectively displays a desired color and gray level. Regarding an actual image, if the pixels display improper gray levels, image noise is generated. Therefore, a proper filtering process is required when the image is displayed, so as to adjust an actual display gray level of each of the pixels.

The filtering process can adjust the gray levels of the pixels to filter the noise. However, if an excessive filtering process is performed to filter the noise, details of the image is also weakened, which may lead to unclearness of the image.

FIG. 1 is a schematic diagram illustrating a processing method of a conventional image noise filtering technique. Referring to FIG. 1, a target pixel 104 and peripheral pixels thereof form a filtering window 102. The target pixel 104 of the filtering window 102 moves relative to each of the pixels, so that the filtering window 102 can move along with the target pixel 104, so as to filter a noise component of the target pixel 104. However, regarding some details on the image, for example, an edge 100 an object, when the filtering window 102 moves, and a peripheral pixel 106 starts to touch the edge 100 of the object, a feature of the edge 100 is smoothly weakened, and if an adjusting degree is too strong, the feature of the edge 100 is excessively weakened or even disappeared, which may influence an image quality.

A general filtering technique, for example, a general Sigma filtering technique is described below. FIG. 2 is a schematic diagram illustrating a flow of the Sigma filtering technique. Referring to FIG. 1 and FIG. 2, a difference calculation unit 120 receives gray levels of the target pixel 104 and the peripheral pixels 106 neighboring to the target pixel 104. The difference calculation unit 120 calculates absolute differences of the peripheral pixels 106 and the target pixel 104. Then, a weighting unit 122 obtains a weight value of each of the peripheral pixels 106 through a table look-up method according to the absolute value of each of the peripheral pixels 106. Such weight values can be averaged at the filtering window 102, so as to adjust the gray level of the target pixel 104.

According to the above conventional filtering method, the image details can be excessively adjusted to lose a sharpness of the image detail.

### SUMMARY

Accordingly, the present disclosure is directed to a filtering technique for reducing image noise, by which during a process of filtering the image noise, image details are preserved as much as possible.

The present disclosure provides a filter for reducing image noise, which includes a sum of absolute difference (SAD) unit and a weighting unit. The SAD unit receives a plurality of pixels of a target window and receives a plurality of pixels of a plurality of peripheral windows, which are neighboring to a target pixel of the target window. Each of the peripheral windows has a peripheral pixel neighboring to the target pixel. The SAD unit calculates an absolute difference for each of the pixels corresponding to the target window and the peripheral window. A difference calculation is performed on the absolute differences to obtain a difference analysed value. The weighting unit receives each of the difference analysed values, and obtains a plurality of weights corresponding to the peripheral pixels according to a data table.

The present disclosure provides a filtering method for reducing image noise, which is suitable for filtering noises of an image. The method can be described as follows. A target widow is determined according to a target pixel, wherein the target window has a pixel pattern. A plurality of peripheral pixels is determined according to the target pixel. A peripheral window is determined according to each of the peripheral pixels, wherein the peripheral window also has the pixel pattern. An absolute difference for each of the pixels corresponding to the target window and the peripheral window is calculated. A difference calculation is performed on the absolute differences to obtain a difference analysed value. A plurality of weights corresponding to the peripheral pixels is obtained according to each of the difference analysed values through a table look-up method.

In order to make the aforementioned and other features and advantages of the present disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a processing method of a conventional image noise filtering technique.

FIG. 2 is a schematic diagram illustrating a flow of a Sigma filtering technique.

FIG. 3 is a schematic diagram illustrating an operation mechanism of a filter for reducing image noise according to an exemplary embodiment of the present disclosure.

FIG. 4 is a schematic diagram illustrating a peripheral window according to an exemplary embodiment of the present disclosure.

FIG. 5 is a schematic diagram illustrating a target window according to an exemplary embodiment of the present disclosure.

FIG. 6 is a schematic diagram illustrating an operation mechanism of a filter for reducing image noise according to an exemplary embodiment of the present disclosure.

FIGS. 7-9 are schematic diagrams illustrating methods for selecting a shape of a sum of absolute difference (SAD) window according to exemplary embodiments of the present invention.

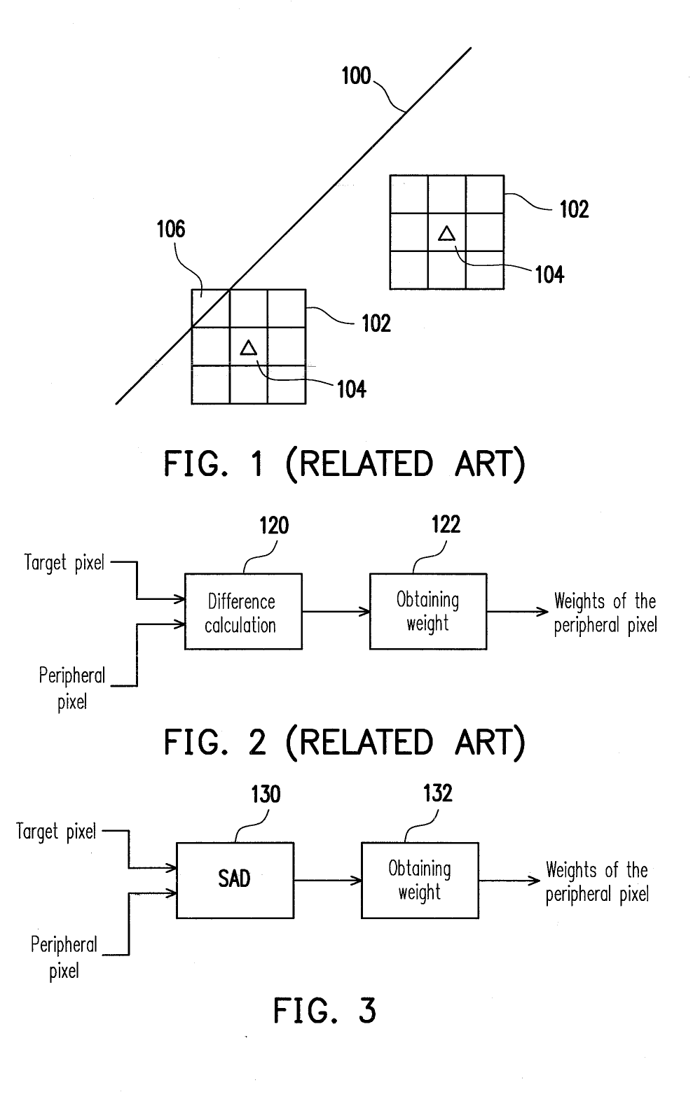

### DETAILED DESCRIPTION OF DISCLOSED EMBODIMENTS

According to the present disclosure, image details can be preserved as much as possible while image noise is filtered. The present disclosure provides a filtering technique for reducing the image noise. A plurality of exemplary embodiments is provided below for describing the present disclosure, though the present disclosure is not limited to the provided exemplary embodiments, and the provided exemplary embodiments can be mutually combined.

FIG. 3 is a schematic diagram illustrating an operation mechanism of a filter for reducing image noise according to an exemplary embodiment of the present disclosure. Referring to FIG. 3, the filter includes a sum of absolute difference (SAD) unit 130 and a weighting unit 132. The SAD unit 130 performs difference analysis to a target pixel and peripheral pixels. The SAD unit 130 receives a plurality of pixels of a target window and receives a plurality of pixels of a plurality of peripheral windows, which are neighboring to a target pixel of the target window. Each of the peripheral windows has a peripheral pixel neighboring to the target pixel.

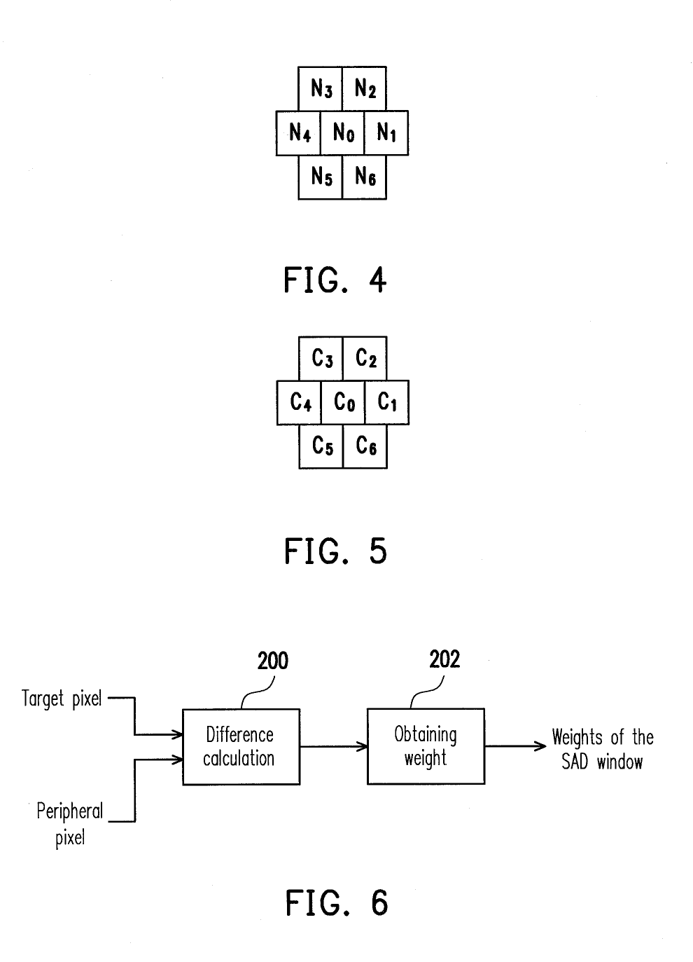

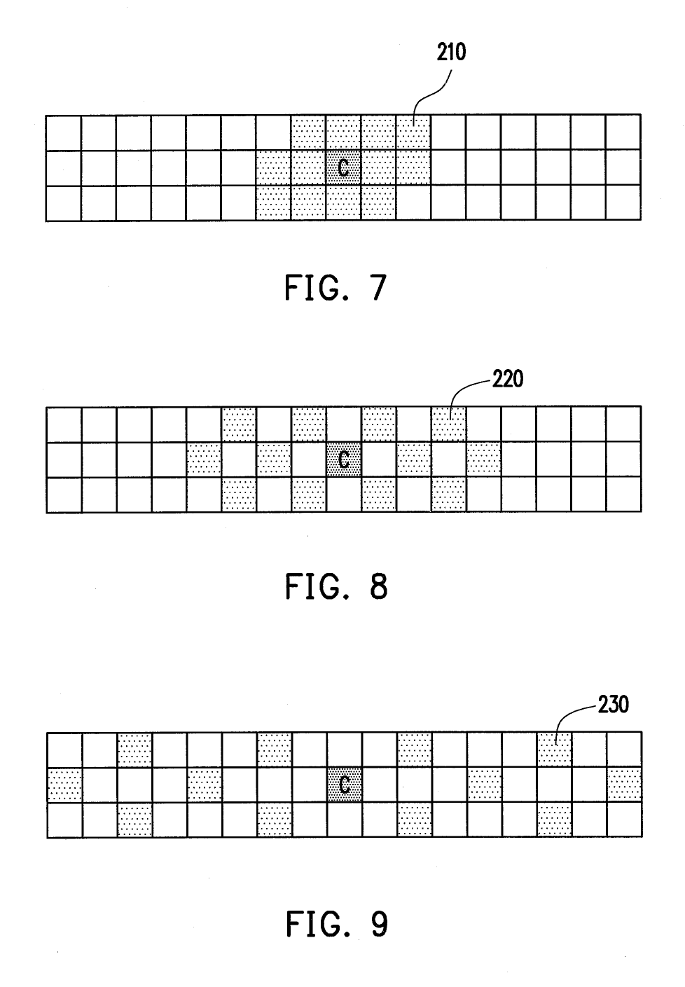

Before a calculation method of the SAD unit 130 is described, the target window and the peripheral windows are first defined. FIG. 4 is a schematic diagram illustrating a peripheral window according to an exemplary embodiment of the present disclosure. FIG. 5 is a schematic diagram illustrating a target window according to an exemplary embodiment of the present disclosure. Referring to FIGS. 4-5, the target window is represented by C and is, for example, formed by 7 pixels C₀-C₆. The peripheral window is represented by N and is, for example, formed by 7 pixels N₀-N₆. A shape of the window is determined by an arranging method of a pixel array and a selected shape, i.e. a shape of a pixel pattern. One target window has a target pixel C₀. One peripheral window has a peripheral pixel N₀. The peripheral pixel N₀ refers to a pixel neighboring to the target pixel C₀. In the present exemplary embodiment, the peripheral pixels N₀ are, for example, 6 peripheral pixels directly neighboring to the target pixel C₀. Further, 6 pixels C1-C6 neighboring to the target pixel C₀ are selected to form the target window according to the shape of the desired pixel pattern. According to the same shape, 6 pixels N1-N6 neighboring to the peripheral pixel N₀ are selected to form the peripheral window. The shapes of the target window and the peripheral window are the same, though selection of the shape is unnecessarily to be the same to the selection method of FIGS. 4-5, which are to be described later with references of FIGS. 7-9.

After the shapes of the target window and the peripheral window are selected as that shown in the exemplary embodiment of FIGS. 4-5, differences (for example, a gray level difference, or differences of other features required to be processed) between the pixels are calculated in a unit of the window.

Referring to FIG. 3 again, the SAD unit 130 calculates an absolute difference for each of the pixels corresponding to the target window and the peripheral window. Then, a difference calculation is performed on the absolute differences to obtain a difference analysed value. In detail, the absolute differences of the pixels C_{0,1 , . . . 6} and the pixels N_{0,1 , . . . 6} are respectively calculated. In an exemplary embodiment, the SAD unit 130 sums the 7 absolute differences to obtain a window difference corresponding to the peripheral pixels N₀. The peripheral pixels N₀ are plural relative to the target pixel C₀. According to the same method, the window difference of each of the peripheral pixels N₀ is calculated.

Further, according to a difference analysis method, other operations (for example, a square operation or other power operations) can be first performed the absolute differences before the absolute differences are summed. Alternatively, another difference analysis mechanism can be used to obtain the difference analysed value. Moreover, when the target pixel is located at a boundary of an actual image, the pixels in the target window are probably beyond the boundary, and the pixels beyond the boundary can be set to zero or a predetermined value, so as to facilitate the calculation.

After the SAD unit 130 calculates the difference analysed value of each of the peripheral pixels relative to the target pixel, the SAD unit 130 transmits the difference analysed values to the follow-up weighting unit 132 to obtain weights of the peripheral pixels. The weighting unit 132 can obtain the weights corresponding to the peripheral pixels according to a data table. The data table includes data obtained according to experiences, or can be determined by a user to serve as one of operation options. In other words, the weights assigning to the peripheral pixels are obtained according to a table look-up method to facilitate a follow-up average calculation of the target pixel, so as to adjust a strength of the target pixel, for example, adjust the gray level of the target pixel.

The average calculation is performed according to the weights, wherein the target pixel may also have its own weight, which is determined according to an applied average calculation method. According to a principle of assigning the weights, the greater the difference is, the smaller the weight is, so as to preserve more details of the edge and smooth details of other areas, and according reduce the noise.

According to the same concept as that described above, the SAD unit 130 can also perform the difference calculations to the pixels according to another weighting method. FIG. 6 is a schematic diagram illustrating an operation mechanism of a filter for reducing image noise according to an exemplary embodiment of the present disclosure. Referring to FIG. 6, the target window and the peripheral windows relative to an SAD unit 200 are the same as that described in the exemplary embodiment of FIGS. 4-5, and the difference calculation method of the SAD unit 200 is similar to that of the SAD unit 130 of FIG. 3, and a difference there between is that when the absolute differences of the pixels C_{0,1 , . . . 6} and the pixels N_{0,1 , . . . 6} are calculated, a set of weights is assigned to each of the pixel differences of the corresponding window. The weights can also be obtained according to the table look-up method or a choice by the user.

Then, a weighting unit 202, which is the same to the weighting unit 132 of FIG. 3, assigns a weight to each of SAD windows to facilitate the average calculation. The weights of the SAD windows are representative pixels assigned to the SAD windows, for example, the target pixel and the peripheral pixels relative to the target pixel.

A shape of the pixel pattern of the SAD window can be selected according to the selection method of FIGS. 4-5, and can also be selected according to an indirect neighboring method, and a pixel number thereof is not limited to the direct neighboring peripheral pixels. FIGS. 7-9 are schematic diagrams illustrating methods for selecting a shape of the SAD window according to exemplary embodiments of the present invention. The exemplary embodiments of FIGS. 7-9 are used to describe the variations of the selection method, though the present disclosure is not limited thereto.

Referring to FIG. 7, taking three bars of pixels as an example, in case of the selection method of the neighboring pixels, a pixel C is taken as the target pixel, and sampling points of an SAD window 210 can be more than one consecutive pixels, and a total number thereof is not limited to the 8 peripheral pixels.

Referring to FIG. 8, the pixel C is taken as the target pixel, and taking three bars of pixels as an example, sampling points of an SAD window 220 can be pixel patterns with an interval of one pixel.

Referring to FIG. 9, the pixel C is taken as the target pixel, and taking three bars of pixels as an example, sampling points of an SAD window 230 can be pixel patterns with an interval of two pixels.

In other words, the shape of the SAD window can be determined according to an actual requirement, and in a same image, different regions may include the SAD windows of different shapes.

In the image filtering process of the present disclosure, the differences are measured according to the SAD windows instead of individual pixels. In this way, more image details can be preserved during the filtering process.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A filter for reducing image noise, comprising:
a sum of absolute difference (SAD) unit, for receiving a plurality of pixels of a target window and receiving a plurality of pixels of a plurality of peripheral windows, which are neighboring to a target pixel of the target window, and each of the peripheral windows having a peripheral pixel neighboring to the target pixel, wherein the SAD unit calculates an absolute difference for each of the pixels corresponding to the target window and the peripheral window, and a difference calculation is performed on the absolute differences to obtain a difference analysed value; and
a weighting unit, for receiving each of the difference analysed values and obtaining a plurality of weights corresponding to the peripheral pixels according to a data table.

2. The filter for reducing image noise as claimed in claim 1, wherein the target window is a pixel pattern at peripheral with reference of the target pixel, and the peripheral window has a same shape as that of the target window with reference of the peripheral pixel.

3. The filter for reducing image noise as claimed in claim 2, wherein the pixels within the pixel pattern are directly neighboring to each other.

4. The filter for reducing image noise as claimed in claim 2, wherein the pixels within the pixel pattern are not all directly neighboring to each other.

5. The filter for reducing image noise as claimed in claim 1, wherein the SAD unit calculates the difference analysed value by directly summing the absolute differences.

6. The filter for reducing image noise as claimed in claim 1, wherein the SAD unit calculates the difference analysed value by summing the absolute differences multiplying an adjusting weight.

7. The filter for reducing image noise as claimed in claim 6, wherein the adjusting weight is adjustable.

8. The filter for reducing image noise as claimed in claim 1, wherein the SAD unit calculates the difference analysed value by summing squares of the absolute differences.

9. The filter for reducing image noise as claimed in claim 1, wherein the SAD unit calculates the difference analysed value by summing squares of the absolute differences multiplying an adjusting weight.

10. The filter for reducing image noise as claimed in claim 9, wherein the adjusting weight is adjustable.

11. The filter for reducing image noise as claimed in claim 1, wherein shapes of the target window and the peripheral window are the same and fixed.

12. The filter for reducing image noise as claimed in claim 1, wherein shapes of the target window and the peripheral window are the same and are varied according to an image content.

13. A filtering method for reducing image noise, suitable for filtering noises of an image, comprising:
determining a target widow according to a target pixel, wherein the target window has a pixel pattern;
determining a plurality of peripheral pixels according to the target pixel;
determining a peripheral window according to each of the peripheral pixels, wherein the peripheral window also has the pixel pattern;
calculating an absolute difference for each of the pixels corresponding to the target window and the peripheral window;
performing a difference calculation on the absolute differences to obtain a difference analysed value; and
obtaining a plurality of weights corresponding to the peripheral pixels according to each of the difference analysed values through a table look-up method.

14. The filtering method for reducing image noise as claimed in claim 13, wherein the target window is selected a pixel pattern at peripheral with reference of the target pixel, and the peripheral window has a same shape as that of the target window with reference of the peripheral pixel.

15. The filtering method for reducing image noise as claimed in claim 14, wherein the pixels within the pixel pattern are directly neighboring to each other.

16. The filtering method for reducing image noise as claimed in claim 14, wherein the pixels within the pixel pattern are not all directly neighboring to each other.

17. The filtering method for reducing image noise as claimed in claim 13, wherein the difference analysed value is calculated by directly summing the absolute differences.

18. The filtering method for reducing image noise as claimed in claim 13, wherein the difference analysed value is calculated by summing the absolute differences multiplying an adjusting weight.

19. The filtering method for reducing image noise as claimed in claim 18, further comprising adjusting the adjusting weight.

20. The filtering method for reducing image noise as claimed in claim 13, wherein the difference analysed value is calculated by summing squares of the absolute differences.

21. The filtering method for reducing image noise as claimed in claim 13, wherein the difference analysed value is calculated by summing squares of the absolute differences multiplying an adjusting weight.

22. The filtering method for reducing image noise as claimed in claim 21, further comprising adjusting the adjusting weight.

23. The filtering method for reducing image noise as claimed in claim 13, further comprising setting shapes of the target window and the peripheral window to be the same and fixed.

24. The filtering method for reducing image noise as claimed in claim 13, further comprising setting shapes of the target window and the peripheral window to be the same and to be varied according to an image content.
